(19) United States
(12) Patent Application Publication
(10) Pub. No.: US 2026/0175527 A1
(43) Pub. Date: Jun. 25, 2026

(54) 3D PRINT REPAIR WITH SUPPORT STRUCTURES

(71) Applicant: INTERNATIONAL BUSINESS MACHINES CORPORATION, Armonk, NY (US)

(72) Inventors: Randy A. Rendahl, Raleigh, NC (US); Sarbajit Kumar Rakshit, Kolkata (IN); Tushar Agrawal, West Fargo, ND (US); Carolina Garcia Delgado, Zapopan (MX)

(21) Appl. No.: 18/987,657

(22) Filed: Dec. 19, 2024

(51) Int. Cl. B29C 73/24; B29C 64/386; B33Y 10/00; B33Y 50/00

(52) U.S. Cl. CPC B29C 73/24; B29C 64/386; B33Y 10/00; B33Y 50/00

(57) ABSTRACT

A method includes creating a digital three-dimensional (3D) model of a hole in an object. A support structure is manufactured based on the digital 3D model. The support structure is positioned on the hole. The hole is repaired by 3D printing over the support structure.

### BACKGROUND

The present invention generally relates to structural repairs using three-dimensional (3D) printing, and more particularly, to systems and methods that repair defects in objects using preformed structural elements to enable 3D printing repairs.

3D printing is a technology employed for creating 3D objects. The technology is based on unique printers that process computer models and print corresponding objects in layers. At the same time, 3D printing is used for repairing different types of cracks and broken portions of an object. 3D printers have difficulties when a large hole needs to be repaired in complex shaped objects. This is especially true in pipes where a wall of the pipe is thin and the hole is large. In such cases, 3D printing repairs of the hole are difficult if not impossible.

### SUMMARY

In accordance with an embodiment of the present invention, a method includes creating a digital three-dimensional (3D) model of a hole in an object. A support structure is manufactured based on the digital 3D model. The support structure is positioned on the hole. The hole is repaired by 3D printing over the support structure.

In accordance with another embodiment of the present invention, a computer system, includes a processor set, one or more computer-readable storage media and program instructions stored on the one or more computer-readable storage media to cause the processor set to perform operations. The operations include creating a digital three-dimensional (3D) model of a hole in an object; 3D printing a support structure based on the digital 3D model; controlling positioning of the support structure on the hole; and 3D printing over the support structure to repair the hole.

In accordance with another embodiment of the present invention, a computer program product includes one or more computer-readable storage media; and program instructions stored on the one or more computer-readable storage media to perform operations. The operations include creating a digital three-dimensional (3D) model of a hole in an object; controlling a 3D printer to manufacture a support structure based on the digital 3D model; controlling positioning of the support structure on the hole; and controlling a 3D printer to 3D print over the support structure to repair the hole.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows a sequence of cross-sectional views of a pipe being repaired, in accordance with an embodiment of the present invention;

FIG. 2 is a schematic diagram showing a defect converted to a digital model, in accordance with an embodiment of the present invention;

FIG. 3 is a schematic diagram showing the defect employed to manufacture a preform or a support structure for use in repairing a defect, in accordance with an embodiment of the present invention;

FIG. 4 is a schematic diagram showing the preform or a support structure inserted and held by a robot system while 3D printing for use in repairing a defect, in accordance with an embodiment of the present invention;

FIG. 5 is a block/flow diagram showing a system/method for repairing an object using a support structure and 3D printing, in accordance with an embodiment of the present invention;

FIG. 6 is a schematic block diagram showing a computing environment for repairing an object using a support structure and 3D printing, in accordance with an embodiment of the present invention; and

FIG. 7 is a flow diagram showing methods for repairing an object using a support structure and 3D printing, in accordance with an embodiment of the present invention.

### DETAILED DESCRIPTION

In accordance with embodiments of the present invention, systems and methods for repairs are described. In an embodiment, systems employ a structural support element prior to making the repair to enable three-dimensional (3D) printing to be employed. In an embodiment, a computer-implemented method can be employed to make repairs. In an example, a repair is to be made to a pipe, which has developed a hole due to corrosion or other damage. Responsive to the hole in the pipe, a size, shape, thickness of the pipe and location of the hole in the pipe are identified. This information can be manually input or can be automatically input using cameras or other sensors. A determination can be made as to whether the hole can be accessed and whether a repair by 3D printing is feasible. A 3D print repair may need to be performed on an operating pipe in the field. Feasibility to 3D print repair directly onto the pipe needs to be considered and further consideration is needed as to whether a repair can be done without any physical support.

A shape and diameter of the pipe can be analyzed by creating a digital 3D model of the hole. A 3D object is manufactured which can be used for closing the hole in the pipe. This 3D object can be separately 3D printed based upon features of the hole. The 3D object can include features to provide support to hold the 3D object in place over or one the hole during a repair 3D print. Appropriate material is selected for printing the 3D object which can be assembled on the hole of the pipe. The 3D printed object design can include a number of layers and different materials selected to cover the dimensions of the hole. A robotic system can be utilized to fix or assemble the printed or manufactured 3D object in or over the hole.

In an embodiment, 3D printing can be combined with the repair of the hole by printing over the 3D object and the hole to repair the pipe. 3D printing can include casting or other fabrication processes to provide the opportunity to accelerate print jobs that have highly variable levels of detail ranging from fine grained printing requiring a fine printer nozzle to large block fill items that need a volume filled rapidly. Highly detailed areas can be built up using the 3D print nozzle while the volume can be filled in parallel by, e.g., a casting model.

Systems and methods for repairing structural defects in objects, such as pipes, using 3D printing technology can utilize a preformed structural support element to facilitate the repair process. The structural support element can be a 3D object that is separately manufactured based on the characteristics of the defect, such as its size, shape, and location on the object. The 3D object can be assembled on the defect, providing a physical support for subsequent layers of 3D printing to complete the repair.

In some embodiments, the systems and methods involve a computer-implemented process that includes identifying the characteristics of the defect, determining the feasibility of a 3D print repair, creating a digital 3D model of the defect, and selecting appropriate materials for the 3D object and the 3D print repair. A robotic system can be employed to assemble the 3D object on the defect. The systems and methods may be applicable to various domains, including but not limited to, electrical, medical, water and sewer delivery applications, etc.

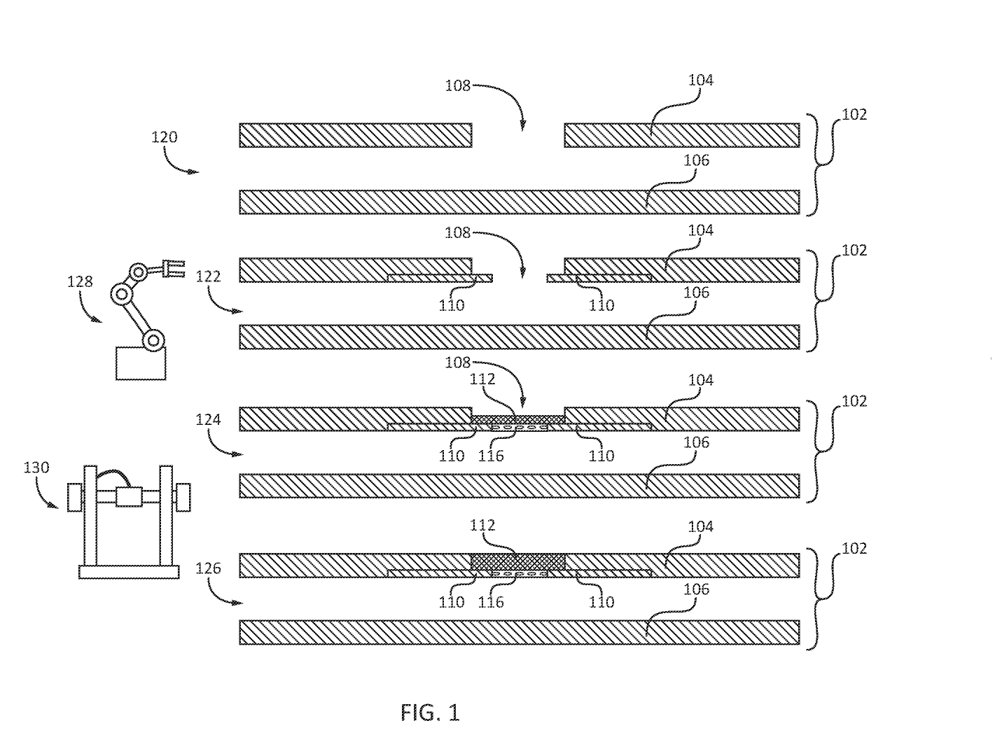

Referring now to the drawings in which like-numerals represent the same or similar elements and initially to FIG. 1, a sequence of cross-sectional views 120, 122, 124, 126 of a pipe 102 in need of repair is shown and described in accordance with embodiments of the present invention. In view 120, the pipe 102 has developed a hole 108 through a top side wall 104. A bottom sidewall of the pipe 102 remains intact. Since the hole 108 needs to be repaired, an evaluation is needed to determine whether a 3D printing system will be able to make the repair to the hole 108 in the pipe 102 due to its size, orientation or other factors. The hole 108 can be cleaned up by sandblasting or other techniques to remove damaged materials.

If a 3D printer 130 will have difficulty in repairing the hole 108, a determination can be made that a support structure 110 needs to be manufactured separately. The hole 108 can be modified before creating a 3D model of the preform or support structure 110 to be used for repairs. The separately manufactured preform or support structure 110 can effectively be placed or assembled on the hole 108 of the pipe 102, and the preform or support structure 110 can provide physical support for subsequent layers of 3D printing.

The hole 108 can be analyzed by employing a computer vision technique to create a 3D model of the pipe 102 and the hole 108 and/or create a 3D model of a support structure 110 that can be inserted within the hole 108 to provide support to enable a 3D printing process repair in view 122. The computer vision techniques can include, e.g., edge detection, shape recognition, and depth estimation, among others.

The 3D model that will be used for repairing the hole 108 in the pipe 102 can be analyzed to determine a best mode or repair, e.g., should the preform or support structure 110 be manufactured with sheet metal, material forming or with a 3D printer, so that the hole 108 in the pipe 102 can be repaired effectively.

In an embodiment, the 3D object or preform can be placed over the hole 108 and fit within the boundaries of the hole 108 to cover the hole 108 in its entirety. In another embodiment, as depicted in FIG. 1, the support structure 110 can be inserted into the pipe 102 to support 3D printing, which can be used for covering the hole. The support structure 110 can be fashioned to include clips, slots, pinches moldings, pins or other features to assist in supporting the support structure 110 on or in the hole.

The support structure 110 is separately manufactured from the process that makes the repair to close the hole 108. After the 3D object, e.g., the support structure 110 or preform is manufactured, then with a combination of a robot 128 and a 3D printer 130, the hole 108 can be repaired with the support structure 110 and 3D printing.

In view 124, after placement of the support structure 110, e.g., using the robot 128, 3D printing is employed to print a one or more layers 112, 116 of print materials. Different materials can be employed for different layers. In view 126, further printing of layer 112 completes the repair of the pipe 102.

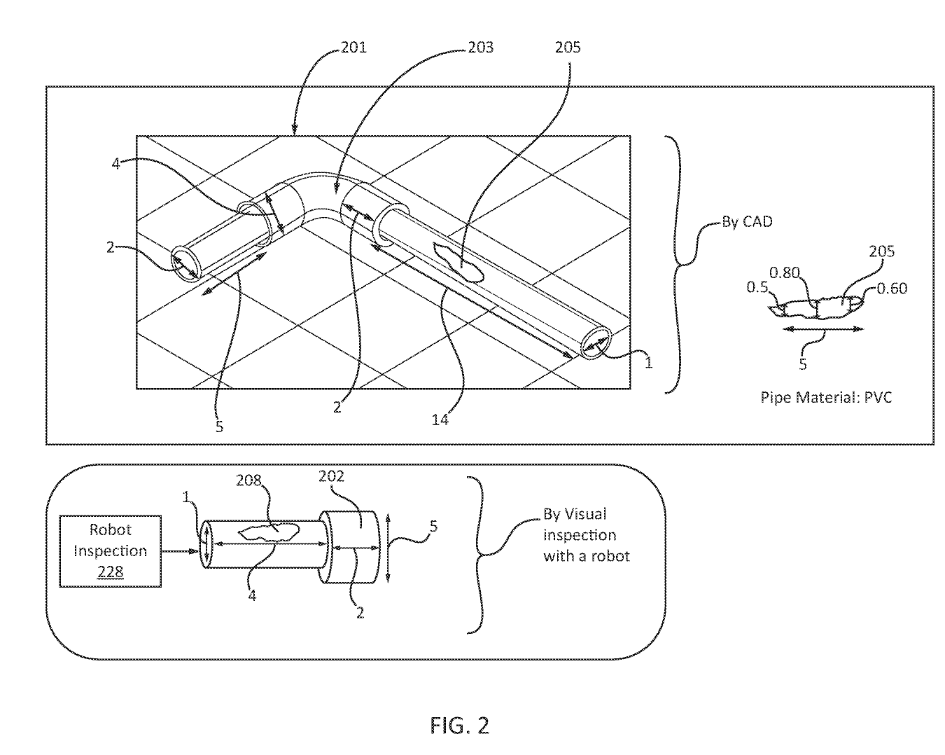

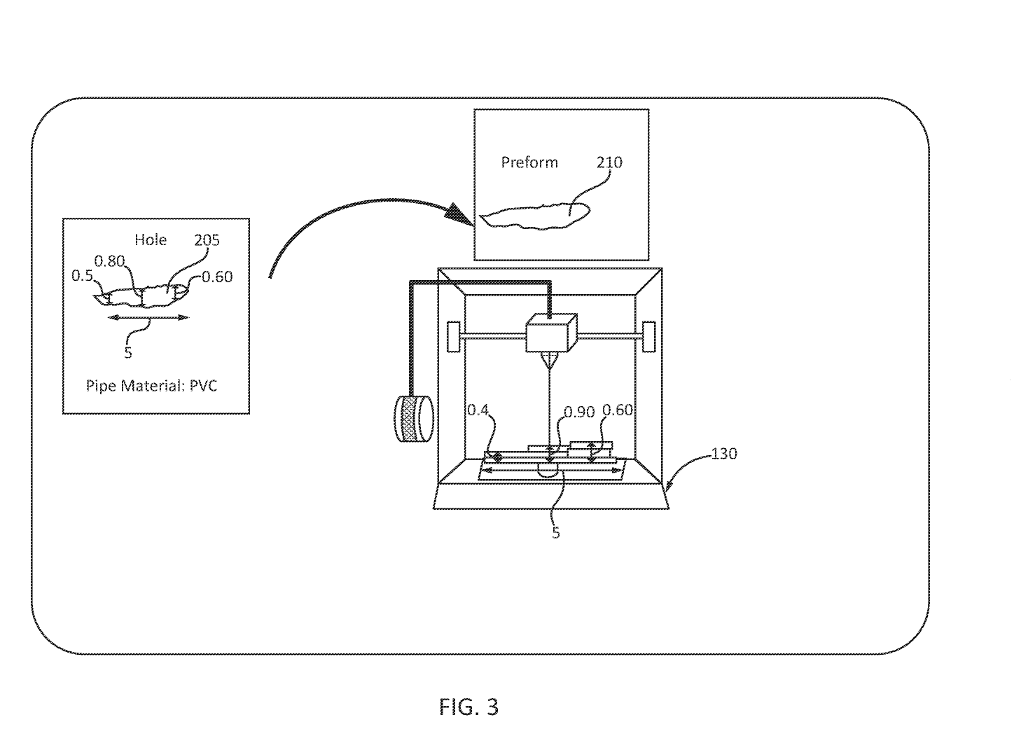

Referring to FIGS. 2 and 3, another repair of a pipe 202 includes forming a preform 210 and then using 3D printing by a 3D printer 130 to complete the repair. The process may begin with an analysis of the damaged area of the pipe 202, including a size, shape, and location of a defect, e.g., hole 208. This analysis may be performed using computer vision techniques or other sensing methods to create a digital 3D model 201 that includes a pipe model 203 and a defect model 205.

Based on this analysis, the preform 210 can be designed and manufactured to fit the specific characteristics of the defect 208. The preform 210 may be created using various manufacturing methods, such as 3D printing, injection molding or machining. The material for the preform 210 may be selected based on its compatibility with the pipe material and its ability to withstand the operating conditions of the pipe. In one example, the pipe can include polyvinyl chloride (PVC) and the preform 210 can include the same material. Other materials can include, e.g., acrylonitrile butadiene styrene (ABS), metals and composites.

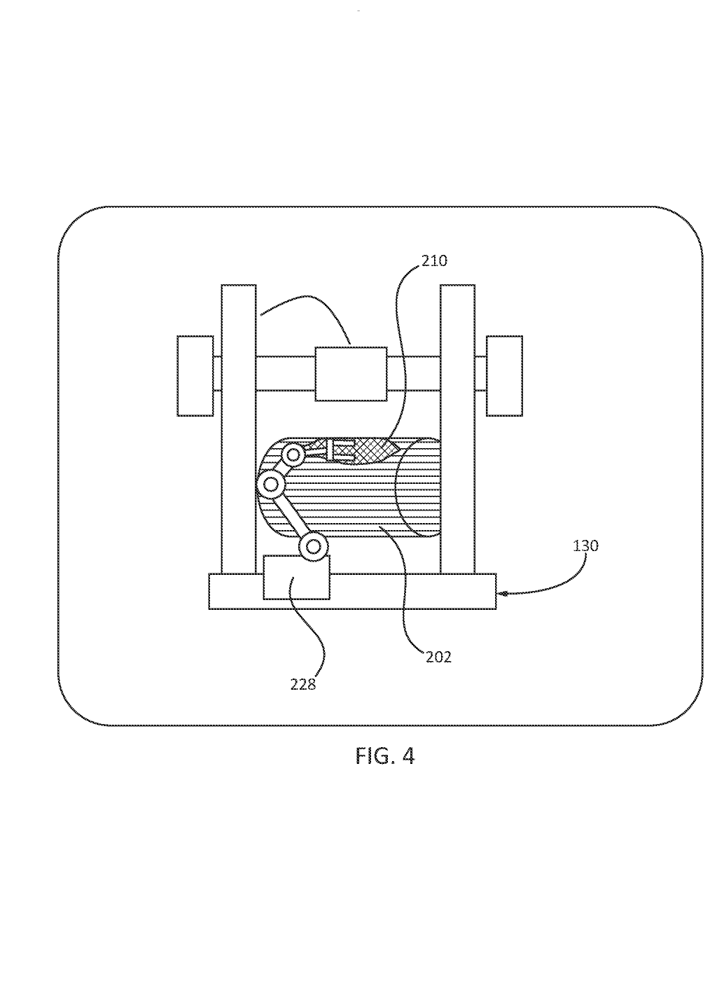

Referring to FIG. 4, once the preform 210 is manufactured, e.g., by 3D printing using a 3D printer 130 or other manufacturing process, the preform 210 can be positioned over the defect in the pipe 202. In some cases, a robotic system 228 can be used to accurately place and secure the preform 210. The preform 210 can serve multiple purposes, e.g., it may provide structural support, act as a base for subsequent 3D printing, and help to seal the defect. The preform 210 can be fabricated with special features to assist in the placement of the preform 210 over or in the hole, e.g., recessed regions, clips, etc.

After the preform 210 is in place, 3D printing may be used to complete the repair. The 3D printing process may involve depositing layers of material over and around the preform 210 to fully integrate the preform 210 with the pipe and create a seamless repair. The material used for 3D printing may be selected to match or complement the properties of the pipe 202 and the preform 210.

In some cases, the 3D printing process may involve multiple stages or materials. For example, an initial layer may be printed to bond the preform 210 to the pipe 202, followed by subsequent layers to build up the repair to the desired thickness and strength. The 3D printing may also incorporate reinforcing materials or structures to enhance the durability of the repair. Throughout the repair process, sensors and monitoring systems may be used to ensure the quality and integrity of the repair. These systems may provide real-time feedback, allowing for adjustments to be made during the 3D printing process if necessary.

The combination of the preform 210 with 3D printing can offer immediate structural support and help to define the shape of the repair, while the 3D printing permits customization and precise material deposition to complete the repair. This approach may be particularly useful for large or complex defects where direct 3D printing alone may be challenging or time-consuming. It should be understood that while a pipe repair application is described, the present embodiments can include other applications, e.g., in electrical, medical, water and sewer delivery with various types of use cases beyond a pipe.

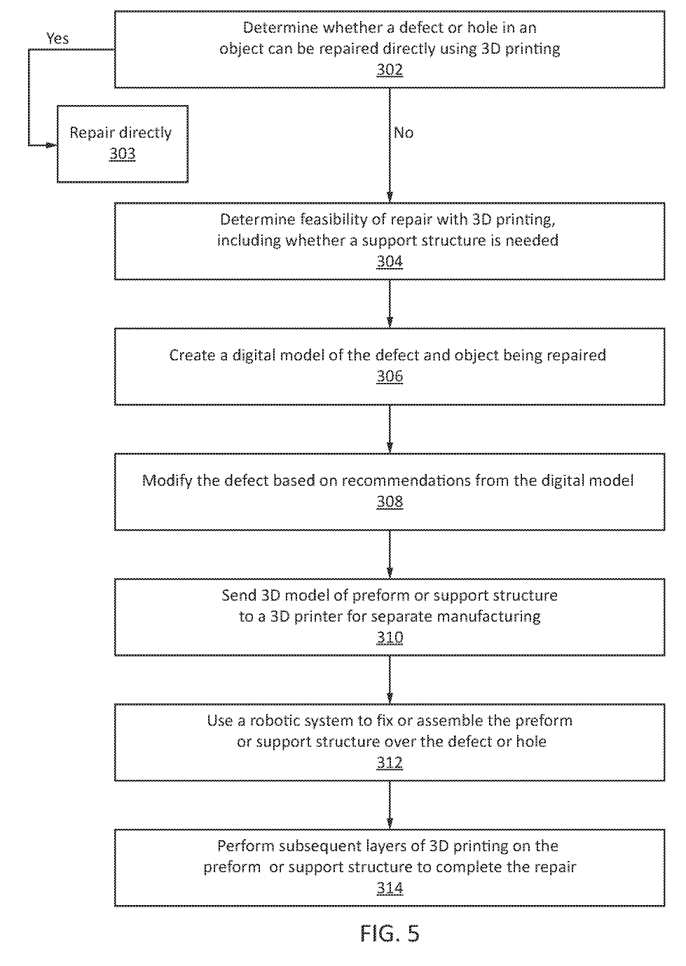

Referring to FIG. 5, a flow diagram describes methods for repairing an object using a support structure and 3D printing in accordance with the present embodiments. In block 302, a determination is made as to whether a defect or hole in an object can be repaired directly using 3D printing. If the defect can be repaired directly, the defect is repaired directly with 3D printing in block 303. If not, in block 304, a determination of feasibility of repair with 3D printing is made to repair a defect. The feasibility includes determination whether a support structure is needed to enable 3D printing. If 3D printing cannot be employed, alternative repairs techniques are considered. If the repair is feasible with 3D printing, a computer vision technique is employed to determine the geometry of the defect. The defect can be prepared before employing the computer vision. For example, damaged materials can be removed or the defect can be resized to create a favorable repair scenario. The computer vision will identify the size, shape, thickness of the pipe and location of the hole in the pipe, and can determine if the hole can be accessed. The feasibility determination as to whether a 3D print repair can be directly made without any physical support (generally small hole or crack can be repaired without any physical support) can be made by a computer. The analysis of the defect and a preform or support structure can be generated using computer aided design (CAD) or by visual inspection with a robot.

In block 306, a digital model is created for the defect and the object being repaired (e.g., pipe). The digital model can identify the characteristics of the defect such as dimensions at different points, lengths and widths, etc. In an embodiment, a digital twin can be created to identify and characterize missing material that is needed for reconstruction. Based on the shape, and dimension of the hole, the digital model will be employed to evaluate the self-weight of the 3D printing material and will identify if there can be any deformation based on historical learning. If based on historical learning or with pre-configuration information, the digital model can be used to identify if the 3D printing-based correction of the defect is not possible, and the object to be used for covering the hole needs to be manufactured separately. The computer vision technique can analyze the shape, diameter and thickness of the pipe, to create a digital 3D model of the defect to identify how the preform or support structure is to be manufactured for closing the defect (e.g., a hole in the pipe). Based on the identified thickness of the pipe, a reduced thickness for the preform or support structure can be employed.

The defect can be modified in block 308. The digital model can make recommendations as to cutting shapes that can be made to the defect to make repair easier or better. Boundaries or edges of the defect can be modified, so that a physical support can be placed over or in the defect or hole. In one example, edges of the hole can be modified to create a surface for attaching the support structure. This can include slots or other structures to assist in alignment, attachment or sealing the hole. The cutting system can be a laser based cutting system and can be deployed by a robot. The boundaries or edges can be shaped to allow bonding between the 3D print and the object being repaired (e.g., a pipe).

In block 310, the 3D model of the preform or support structure can be sent to a 3D printer to be printed separately from the repair with a separate 3D printing process. The preform or support structure can be printed with appropriate material, and can be the same that will be used for covering the defect or hole or the material can be different. The preform or support structure may have a comparatively less thickness than that of the thickness of the pipe wall. The 3D printer can apply different layers of materials that can have different material compositions for the preform or support structure. Additionally, the material will be assessed to ensure a suitable print material can be used that will bond with the part under repair and match the material specification for the part (e.g., handle pressure in the pipe). The printed the preform or support structure provides physical support for the repair on the defect or hole, and at the same time will close/seal the defect or hole on the pipe.

In block 312, a robotic system can be employed to fix or assemble the preform or support structure over the defect or hole. The preform or support structure can be employed to close or seal the hole in the pipe. The robotic system can position/align the preform or support structure with respect to the damaged object (e.g., pipe). In some cases, the edges of the hole and the manufactured item may allow the preform or support structure to rest in position without additional support, but in others the robot system will maintain control while the initial 3D printing occurs (once stable, the robotic system’s support could be removed to permit subsequent printing). The initial 3D printing can effectively form a bond between the object under repair and the preform or support structure (effectively welding it in place). The preform or support structure is used for closing the hole acts as physical support for subsequent layers of 3D printing.

In block 314, subsequent layers of 3D printing on the preform or support structure is performed. The 3D printer can select one or more types of materials for reinforcement and gradually can close the defect or hole on the object (e.g., pipe). A surface can be placed on a last layer or layers to provide aesthetics or to match the texture/color or other portions of the object being repaired.

In some cases, the 3D printing process may involve multiple stages or materials. For example, an initial layer may be printed to bond the preform to the pipe, followed by subsequent layers to build up the repair to the required thickness and strength. The 3D printing may also incorporate reinforcing materials or structures to enhance the durability of the repair.

Throughout the repair process, sensors and monitoring systems may be used to ensure the quality and integrity of the repair. These systems may provide real-time feedback, allowing for adjustments to be made during the 3D printing process if necessary.

The combination of a preform with 3D printing may offer several advantages. The preform may provide immediate structural support and help to define the shape of the repair, while the 3D printing allows for customization and precise material deposition to complete the repair. This approach may be particularly useful for large or complex defects where direct 3D printing alone may be challenging or time-consuming.

In some aspects, the systems and methods for repairing structural defects may be applied to a variety of structures beyond pipes. The structural defects in these components may include cracks, breaks, or other types of damage that may affect the electrical conductivity or the mechanical stability of the components. In some cases, the systems and methods may be used to repair structural defects in medical devices, such as prosthetics or implants. The structural defects in these devices may include fractures, wear, or other types of damage that may affect the functionality or the biocompatibility of the devices. In some aspects, the system and method may be used to repair structural defects in water and sewer delivery systems, such as pipes, valves, or tanks. The structural defects in these systems may include leaks, corrosion, or other types of damage that may affect the water flow or the structural integrity of the systems.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

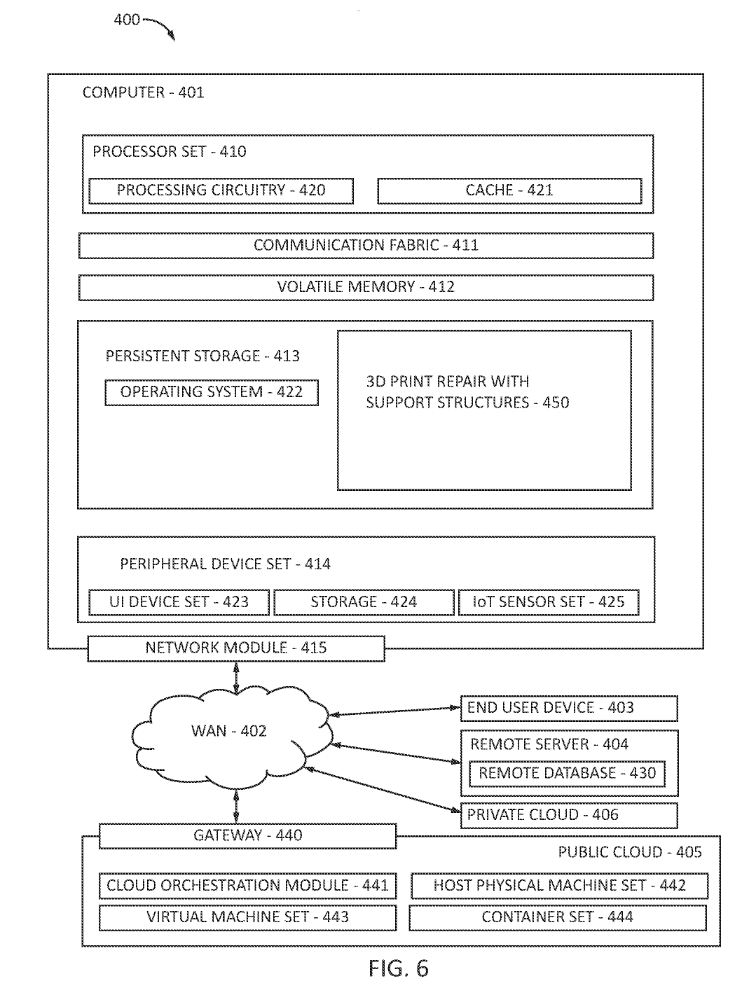

Referring to FIG. 6, a computing environment 400 contains an example of an environment for the execution of at least some of the computer code involved in performing the inventive methods, such as, 3D print repair with support structures 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 6. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444.

It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

In some aspects, the system for repairing structural defects may include a hardware processor and a memory. The hardware processor may be configured to execute a computer program stored in the memory. The computer program, when executed by the hardware processor, may cause the hardware processor to perform various operations related to the repair of structural defects. For instance, the hardware processor may be configured to receive and process data related to the structural defect, such as its size, shape, and location on the object. The hardware processor may also be configured to determine the feasibility of a 3D print repair based on the received data. In some cases, the hardware processor may be configured to create a digital 3D model of the defect based on the received data.

The memory, on the other hand, may be a non-transitory computer-readable medium that stores computer programs. The computer programs may include instructions for performing the various operations related to the repair of defects. In some cases, the memory may also store data related to the defect, such as its size, shape, and location on the object.

In some aspects, the system may also include a 3D printer configured to manufacture a 3D object based on the digital 3D model created by the hardware processor. The 3D printer may be configured to use a material selected based on the characteristics of the defect and the object. In some cases, the 3D printer may be configured to assemble the 3D object on the defect, providing a physical support for subsequent layers of 3D printing to complete the repair.

In some aspects, the computer-implemented method for repairing a structural defect may involve receiving data related to the structural defect, determining the feasibility of a 3D print repair based on the received data, creating a digital 3D model of the defect based on the received data, selecting a material for the 3D object and the 3D print repair based on the characteristics of the defect and the object, and instructing a 3D printer to manufacture and assemble the 3D object on the defect.

In some cases, the computer-implemented method may also involve using a robotic system to assemble the 3D object on the defect. The robotic system may be configured to move the 3D object to the location of the defect and to position the 3D object on the defect in a manner that provides a physical support for subsequent layers of 3D printing to complete the repair.

In some aspects, the computer-implemented method and the system may be used to repair structural defects in various types of objects, such as pipes, electrical components, medical devices, and water and sewer delivery systems. The structural defects may include holes, cracks, and other types of damage that may affect the structural integrity of the objects.

In some aspects, the hardware processor may be configured to use machine learning algorithms to identify the structural defect and to guide the modification of the hole edges. The machine learning algorithms may be trained on a dataset of 3D models of structures with various types of structural defects, which may include holes, cracks, and other types of damage. The machine learning algorithms may learn to recognize patterns or features that are indicative of structural defects, and to predict the optimal modifications for the hole edges based on these patterns or features. In some cases, the machine learning algorithms may use supervised learning techniques, which involve the use of labeled training data. In other cases, the machine learning algorithms may use unsupervised learning techniques, which involve the use of unlabeled training data.

In some aspects, the hardware processor may be configured to receive feedback from the 3D printer or other sensors during the repair process. This feedback may include data related to the placement of the physical support structure, the quality of the 3D print repair, or the performance of the structure after the repair. The hardware processor may use this feedback to adjust the modification of the hole edges or the design of the physical support structure, which may help to improve the effectiveness of the repair. In some cases, the feedback may be used to update the machine learning algorithms, which may help to improve their accuracy or efficiency in identifying structural defects and guiding the modification of the hole edges.

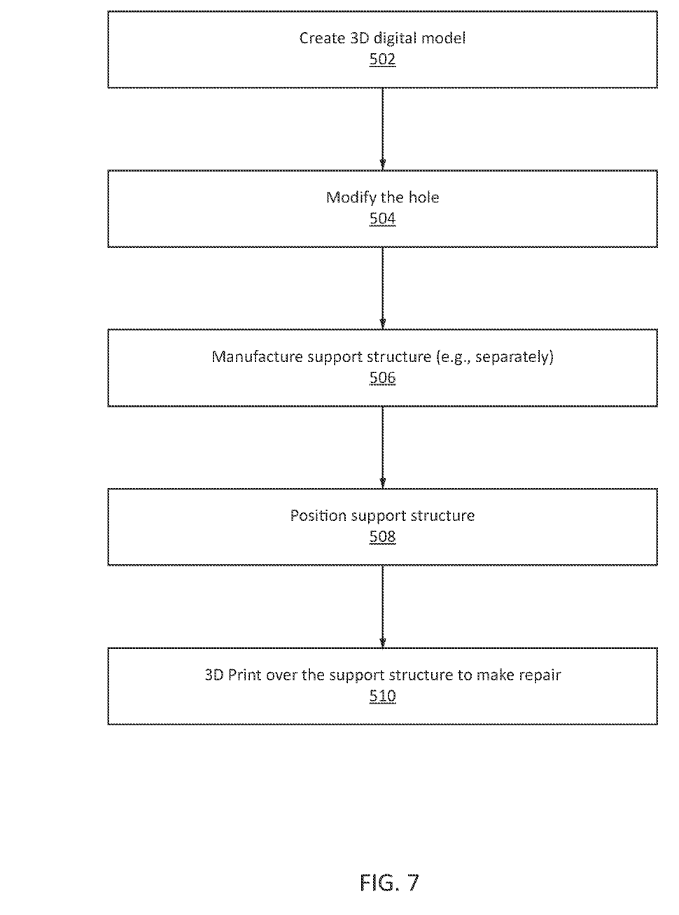

Referring to FIG. 7, systems and methods for repairing a defect are described and shown. In some embodiments, some or all steps described can be controlled using software. In block 502, a digital three-dimensional (3D) model of a hole in an object (e.g., a pipe) is created. This can include creating the digital 3D model of the hole by using computer vision techniques to analyze a geometry of the hole, e.g., the computer vision techniques can include edge detection, shape recognition, and depth estimation. In block 504, a computer controlled laser or other tool can be employed to modify the hole. This can include modifying edges of the hole to create a surface for attaching the support structure (e.g., forming corresponding slots or other features to improve fit or to assist in applying the preform or support structure).

In block 506, a support structure is manufactured based on the digital 3D model. The manufacture of the support structure can include 3D printing the support structure separately from 3D printing to repair the hole. In block 508, the support structure can be positioned on the hole. The positioning of the support structure can include employing a robot system to hold the support structure during initial 3D printing. In block 510, 3D printing is performed over the support structure to repair the hole. The support structure can be printed with a thickness that is less than a wall thickness of the object (e.g., a pipe) or include other custom designed features to assist in placing the support structure on the hole.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method, comprising:
creating a digital three-dimensional (3D) model of a hole in an object;
manufacturing a support structure based on the digital 3D model;
positioning the support structure on the hole; and
3D printing over the support structure to repair the hole.

2. The method of claim 1, wherein creating the digital 3D model of the hole comprises using computer vision techniques to analyze a geometry of the hole.

3. The method of claim 2, wherein the computer vision techniques include edge detection, shape recognition, and depth estimation.

4. The method of claim 1, wherein 3D printing the support structure comprises 3D printing the support structure with a thickness that is less than a wall thickness of the object.

5. The method of claim 1, wherein manufacturing the support structure includes 3D printing the support structure separately from 3D printing to repair the hole.

6. The method of claim 1, further comprising modifying edges of the hole to create a surface for attaching the support structure.

7. The method of claim 1, wherein positioning the support structure on the hole includes employing a robot system to hold the support structure during initial 3D printing.

8. The method of claim 1, wherein the object includes a pipe.

9. A computer system, comprising:
a processor set;
one or more computer-readable storage media; and
program instructions stored on the one or more computer-readable storage media to cause the processor set to perform operations comprising:
creating a digital three-dimensional (3D) model of a hole in an object;
3D printing a support structure based on the digital 3D model;
controlling positioning of the support structure on the hole; and
3D printing over the support structure to repair the hole.

10. The system of claim 9, wherein the digital 3D model is created using computer vision techniques to analyze a geometry of the hole.

11. The system of claim 10, wherein the computer vision techniques include edge detection, shape recognition, and depth estimation.

12. The system of claim 9, wherein 3D printing the support structure comprises 3D printing the support structure with a thickness that is less than a wall thickness of the object.

13. The system of claim 9, wherein 3D printing the support structure includes 3D printing the support structure separately from 3D printing to repair the hole.

14. The system of claim 9, when the operations further comprise modifying edges of the hole to create a surface for attaching the support structure.

15. The system of claim 9, wherein the operations further comprise employing a robot system to hold the support structure during initial 3D printing.

16. The system of claim 9, wherein the object includes a pipe.

17. A computer program product, comprising:
one or more computer-readable storage media; and
program instructions stored on the one or more computer-readable storage media to perform operations comprising:
creating a digital three-dimensional (3D) model of a hole in an object;
controlling a 3D printer to manufacture a support structure based on the digital 3D model;
controlling positioning of the support structure on the hole; and
controlling a 3D printer to 3D print over the support structure to repair the hole.

18. The computer program product of claim 17, wherein creating the digital 3D model of the hole comprises using computer vision techniques to analyze a geometry of the hole.

19. The computer program product of claim 17, wherein the support structure is 3D printed separately from 3D printing to repair the hole.

20. The computer program product of claim 17, wherein controlling positioning of the support structure includes controlling a robot system to hold the support structure during initial 3D printing.
